(19) United States
(12) Patent Application Publication
(10) Pub. No.: US 2022/0407695 A1
(43) Pub. Date: Dec. 22, 2022

(54) ELECTRONIC DEVICE AND CONTROL METHOD THEREOF

(71) Applicant: SAMSUNG ELECTRONICS CO., LTD., Suwon-si (KR)

(72) Inventors: Woochul SHIM, Suwon-si (KR); Bokdeuk JEONG, Suwon-si (KR)

(73) Assignee: SAMSUNG ELECTRONICS CO., LTD., Suwon-si (KR)

(21) Appl. No.: 17/894,372

(22) Filed: Aug. 24, 2022

Related U.S. Application Data
(63) Continuation of application No. PCT/KR2021/000895, filed on Jan. 22, 2021.

(30) Foreign Application Priority Data
Feb. 24, 2020 (KR) 10-2020-0022322

(51) Int. Cl. H04L 9/08; G06F 21/60

(52) U.S. Cl. CPC H04L 9/0894; G06F 21/602

(57) ABSTRACT

A method of controlling an electronic device is provided. The method includes: identifying a first instruction for an encryption operation on a file using an encryption key; based on the first instruction being identified, obtaining the encryption key and metadata for the encryption operation and storing the obtained encryption key and the metadata in a non-volatile memory; and based on a user command for an access operation to the file being obtained, identifying the encryption key used for the encryption operation based on the metadata.

### CROSS-REFERENCE TO RELATED APPLICATIONS

This application is a bypass continuation of International Application No. PCT/KR2021/000895, filed on Jan. 22, 2021, which is based on and claims priority to Korean Patent Application No. 10-2020-0022322, filed on Feb. 24, 2020, in the Korean Intellectual Property Office, the disclosures of which are incorporated by reference herein in their entireties.

### BACKGROUND

### 1. Field

The disclosure relates to an electronic device and a control method thereof, and more particularly, to an electronic device for performing a decryption operation on a user file encrypted by a malicious program and a control method thereof.

### 2. Description of Related Art

Recently, as security issues caused by malicious programs such as viruses or malware frequently occur, prevention of hacking using vulnerabilities in software and security problems are emerging.

In particular, ransomware is a type of malicious programs that encrypt data of user computers or mobile devices without permission and do not decrypt the data until payment is made to the source of the ransomware, causing enormous damage to a user. Further, it is generally known to be quite difficult to restore data encrypted by the ransomware to its original state.

Accordingly, there is a need for a technology for restoring data encrypted by malicious programs such as ransomware without permission.

### SUMMARY

Provided are an electronic device for identifying an encryption key used for an encryption operation on a user file, and decrypting the user file encrypted by a malicious program, and a control method thereof.

Additional aspects will be set forth in part in the description which follows and, in part, will be apparent from the description, or may be learned by practice of the presented embodiments.

According to an aspect of the disclosure, a method of controlling an electronic device, includes: identifying a first instruction for an encryption operation on a file using an encryption key; based on the first instruction being identified, obtaining the encryption key and metadata for the encryption operation and storing the obtained encryption key and the metadata in a non-volatile memory; and based on a user command for an access operation to the file being obtained, identifying the encryption key used for the encryption operation based on the metadata.

The identifying the encryption key may include identifying the encryption key based on information on a memory address in which the encryption key included in the metadata is stored.

The storing the obtained encryption key and the metadata may include: based on the first instruction being identified, inserting a second instruction for storing the encryption key and the metadata for the encryption operation in the non-volatile memory into a memory address separated by a predetermined value from the memory address in which the first instruction is stored; and based on the second instruction being executed, storing the encryption key and the metadata in the non-volatile memory.

The method may further include setting the first instruction as a privileged instruction to identify the first instruction, and the obtaining the encryption key and the metadata may include, based on a trap being identified as the first instruction set as the privileged instruction is executed, obtaining the encryption key and the metadata through a trap handler that processes the trap.

The storing the encryption key and the metadata may include: based on the first instruction and a memory address in which the first instruction is stored being identified, setting the identified memory address as a breakpoint in a debug register of the electronic device; and based on an interrupt being detected at the breakpoint, executing a predetermined routine to obtain the encryption key and the metadata and storing the obtained encryption key and the metadata in the non-volatile memory.

The method may further include performing a decryption operation on the file using the identified encryption key, and the performing of the decryption operation may include: obtaining at least one encryption key based on information on a time based on the first instruction being executed, and performing the decryption operation on the file using the obtained encryption key.

The storing the obtained encryption key and the metadata may include: identifying other applications excluding a first application having predetermined identification information among at least one application based on the identification information on the at least one application that executes the first instruction, and obtaining an encryption key and metadata for an encryption operation performed by the other applications and storing the encryption key and the metadata for the encryption operation performed by the other applications in the non-volatile memory.

According to an aspect of the disclosure an electronic device includes: a memory configured to store at least one instruction; and a processor configured to execute the at least one instruction to: identify a first instruction for an encryption operation on a file using an encryption key, based on the first instruction being identified, obtain the encryption key and metadata for the encryption operation and store the obtained encryption key and the metadata in a non-volatile memory, and based on a user command for an access operation to the file being obtained, identify the encryption key used for the encryption operation based on the metadata.

The processor may be further configured to execute the at least one instruction to identify the encryption key based on information on a memory address in which the encryption key included in the metadata is stored.

The processor may be further configured to execute the at least one instruction to, based on the first instruction being identified, insert a second instruction for storing the encryption key and the metadata for the encryption operation in the non-volatile memory into a memory address separated by a predetermined value from the memory address in which the first instruction is stored, and based on the second instruction being executed, store the encryption key and the metadata in the non-volatile memory.

The processor may be further configured to execute the at least one instruction to: set the first instruction as a privileged instruction to identify the first instruction, and based on a trap being identified as the first instruction set as the privileged instruction is executed, obtain the encryption key and the metadata through a trap handler processing the trap and stores the obtained encryption key and metadata in the non-volatile memory.

The processor may be further configured to execute the at least one instruction to: based on the first instruction and a memory address in which the first instruction is stored being identified, set the identified memory address as a breakpoint in a debug register of the electronic device, and based on an interrupt being detected at the breakpoint, execute a predetermined routine to obtain the encryption key and the metadata and store the encryption key and the metadata in the non-volatile memory.

The processor may be further configured to execute the at least one instruction to: perform a decryption operation on the file using the identified encryption key, obtain at least one encryption key based on information on a time based on the first instruction being executed, and perform the decryption operation on the file using the obtained encryption key.

The processor may be further configured to execute the at least one instruction to: identify other applications excluding a first application having predetermined identification information among at least one application based on the identification information on the at least one application that executes the first instruction, and obtain an encryption key and metadata for an encryption operation performed by the other applications and store the obtained encryption key and metadata for the encryption operation performed by the other applications in the non-volatile memory.

According to various embodiments of the present disclosure as described above, it is possible to identify an encryption key used for an encryption operation on a user file, and restore the user file using the identified encryption key. Accordingly, it is possible to improve user convenience and satisfaction.

In addition, the effects obtainable or predicted by the embodiments of the present disclosure will be disclosed directly or implicitly in the detailed description of the embodiments of the present disclosure. For example, various effects predicted according to embodiments of the present disclosure will be disclosed in the detailed description to be described later.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for describing a method of controlling an electronic device according to an embodiment of the disclosure;

FIG. 2 is an example of a binary of a malicious program;

FIG. 3 is a diagram illustrating attribute information on a user file encrypted by the malicious program according to an embodiment of the disclosure;

FIG. 4 is a block diagram illustrating a configuration of the electronic device according to the embodiment of the disclosure;

FIG. 5 is a flowchart of a method of controlling an electronic device according to an embodiment of the disclosure;

FIG. 6 is a flowchart of a method of controlling an electronic device according to an embodiment of the disclosure;

FIG. 7 is an example of binary information for describing the control method of FIG. 6; and

FIG. 8 is a diagram for describing a software configuration of an electronic device according to an embodiment of the disclosure.

### DETAILED DESCRIPTION

After terms used in the present specification are briefly described, embodiments of the disclosure will be described in detail.

General terms that are currently widely used were selected as terms used in embodiments of the disclosure in consideration of functions in the disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the disclosure. Therefore, the terms used in embodiments of the disclosure should be defined on the basis of the meaning of the terms and the contents throughout the disclosure rather than simple names of the terms.

The disclosure may be variously modified and have several embodiments, and therefore specific embodiments of the disclosure will be illustrated in the drawings and be described in detail in the detailed description. However, it is to be understood that the disclosure is not limited to specific embodiments, but includes all modifications, equivalents, and substitutions without departing from the scope and spirit of the disclosure. Based on the determination that a detailed description of the known art related to the disclosure may obscure the gist of the disclosure, the detailed description will be omitted.

Terms ‘first’, ‘second’, and the like, may be used to describe various components, but the components are not to be construed as being limited by these terms. The terms are used only to distinguish one component from another component.

Singular forms are intended to include plural forms unless the context clearly indicates otherwise. It should be understood that terms “comprise” or “include” used in the specification, specify the presence of features, numerals, steps, operations, components, parts mentioned in the specification, or combinations thereof, but do not preclude the presence or addition of one or more other features, numerals, steps, operations, components, parts, or combinations thereof.

Hereinafter, embodiments of the disclosure will be described in detail with reference to the accompanying drawings so that those skilled in the art to which the disclosure pertains may easily practice the disclosure. However, the disclosure may be modified in various different forms, and is not limited to embodiments described herein. In addition, in the drawings, portions unrelated to the description will be omitted to obviously describe the disclosure, and similar reference numerals will be used to describe similar portions throughout the specification.

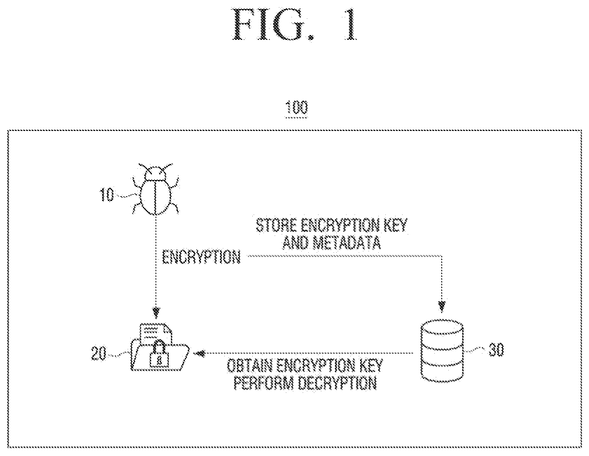

FIG. 1 is a diagram for describing a method of controlling an electronic device according to an embodiment of the disclosure.

Referring to FIG. 1, the electronic device 100 may perform an encryption operation on a user file 20 existing in the electronic device 100 by executing a malicious program 10. In this case, the malicious program 10 may include an instruction for causing the electronic device 100 to perform the encryption operation on the user file 20. Here, the electronic device 100 may be a personal computer (PC), a mobile device, or the like. In addition, the malicious program 10 may be ransomware, malware, or various types of applications.

The electronic device 100 may execute various instructions based on performing the encryption operation on the user file 20. In particular, the electronic device 100 may execute a hardware acceleration instruction to improve a speed of the encryption operation on the user file 20. Here, the hardware acceleration instruction is a command for executing a hardware acceleration function provided to a user terminal, and is, for example, ‘aeskeygenassist’ according to an advanced encryption standard (AES) algorithm. The hardware acceleration instruction may be executed based on performing the encryption operation, but may also be executed during other operations of the electronic device 100.

The electronic device 100 may execute the hardware acceleration instruction used for the encryption operation on the user file 20. Specifically, based on an application installed in the electronic device 100 being executed, the electronic device 100 may scan a binary of the application to determine whether a hardware acceleration instruction exists in the application.

Based on the hardware acceleration instruction being identified, the electronic device 100 may obtain an encryption key used for the encryption operation and metadata for the encryption operation and back the encryption key and the metadata up to the memory 30. Here, the metadata means a series of data for an encryption operation performed by the electronic device 100 and may include information on an encryption key. For example, the metadata may include identification information (for example, the program name that performs the encryption operation, etc.) on a processor (or application) that performs the encryption operation, information on a memory address where the encryption key is stored, information on a length of the encryption key, and information on the time the hardware acceleration instruction is executed.

The electronic device 100 may back up the metadata and the encryption key in various ways.

For example, the electronic device 100 may back up the metadata and the encryption key using a code injection method (binary instrumentation). Specifically, based on the hardware acceleration instruction being identified, the electronic device 100 may insert an instruction for backing up the encryption key and metadata for the encryption operation into an address (e.g., an address immediately following the hardware acceleration instruction) separated by a predetermined distance from the memory address in which the hardware acceleration instruction is stored. In this case, the inserted instruction may include an instruction for storing various types of information on the application, in addition to identification information on the application including the hardware acceleration instruction, and information on the time based on the application being executed. After the insertion of the instruction is completed, based on the identified hardware acceleration instruction and the inserted instruction being sequentially executed, the electronic device 100 may store the encryption key and metadata in the memory 30 by executing the inserted instruction.

As another example, the electronic device 100 may set the hardware acceleration instruction as a privileged instruction. The privileged instruction refers to an instruction that may not be executed with application privileges, and a trap occurs based on the execution of the privileged instruction being attempted at an application level. Here, when the processor tries to use a specific function of the system, the trap refers to a method of requesting an operating system for the function. When a trap occurs, the execution of the privileged instruction is blocked at the application level, and a control privilege is transferred to the operating system (or kernel). In this case, the electronic device 100 may execute the hardware acceleration instruction through the trap handler at the operating system level, obtain the encryption key and the metadata, and store the obtained encryption key and metadata in the memory 30.

As another example, the electronic device 100 may scan an application including the hardware acceleration instruction, identify a memory address in which the hardware acceleration instruction is stored, and set the identified memory address as a break point. Thereafter, based on an interrupt being detected at the set breakpoint, the electronic device 100 may identify that the hardware acceleration instruction is executed. In addition, the electronic device 100 may execute a predetermined routine to obtain an encryption key and metadata and store the obtained encryption key and metadata in the memory 30.

The electronic device 100 may obtain the encryption key based on the metadata stored in the memory 30 according to various methods as described above. Specifically, the electronic device 100 may identify the encryption key based on the information on the memory address in which the encryption key is stored included in the metadata. The electronic device 100 may perform a decryption operation on the user file 20 using the obtained encryption key. In this case, the encryption key may be a symmetric key. The electronic device 100 may identify the encryption key based on various user commands and perform the decryption operation. For example, based on a user command for an access operation to the user file 20 being obtained, the electronic device 100 may identify the encryption key or perform the decryption operation using the identified encryption key. Accordingly, the user may execute the user file 20 that is encrypted due to the malicious program 10 and cannot be executed.

On the other hand, in the related art, based on the user file 20 being encrypted due to the malicious program 10, in particular, ransomware, it is difficult to identify a decryption key (or encryption key) for decrypting the user file 20, and thus, it is difficult to recover the user file 20. Due to this, a user has no choice but to pay a huge cost to a hacker who distributes the malicious program 20 to recover the encrypted file. On the other hand, based on the execution of the hardware acceleration instruction being detected, the electronic device 100 according to the disclosure may store the related metadata in the memory 30 and easily identify the encryption key based on the stored metadata. Accordingly, user satisfaction may be greatly improved by easily recovering the encrypted file.

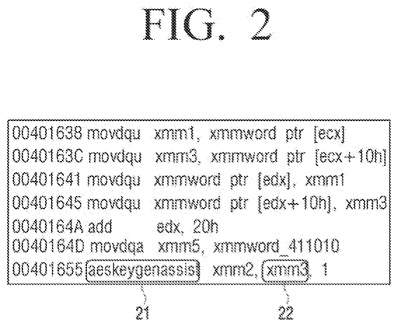

A more detailed description of a method of identifying a hardware acceleration instruction and backing up an encryption key and metadata will be described later with reference to FIGS. 2 to 10.

FIG. 2 is an example of a binary of a malicious program.

Referring to FIG. 2, the malicious program 10 may include various instructions. In particular, the malicious program 10 may include a hardware acceleration instruction 21. For example, the hardware acceleration instruction 21 may be ‘aeskeygenassist’ according to an advanced encryption standard (AES) algorithm. However, this is only an example, and various types of hardware acceleration instructions 21 may exist. The binary of the malicious program 10 includes ‘xmm3’, which is an operand 22 for the hardware acceleration instruction 21, and the encryption key may be stored in a memory location corresponding to ‘xmm3’. As described above, the electronic device 100 may identify ‘aeskeygenassist’, which is the hardware acceleration instruction 21, obtain metadata including the identification information on the processor calling the ‘aeskeygenassist’, the information on the encryption key stored in the xmm3, and the information on the time based on the ‘aeskeygenassist’ being called based on the identified ‘aeskeygenassist’, and store the obtained metadata in the memory 30.

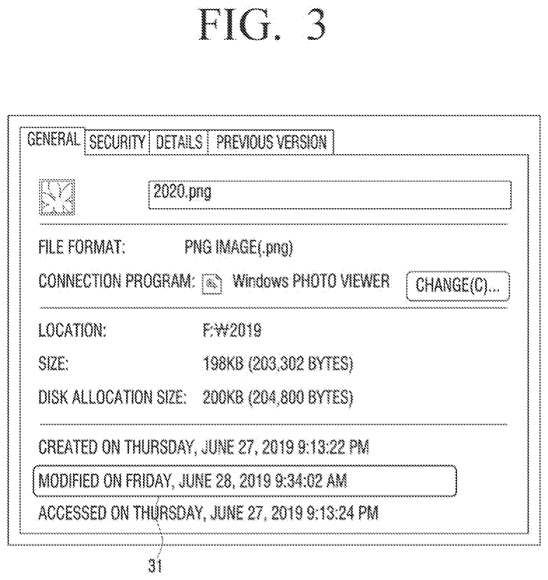

FIG. 3 is a diagram illustrating attribute information on the user file 20 encrypted by the malicious program 10 according to the embodiment of the disclosure. Referring to FIG. 3, the user may predict the time based on the encryption operation being performed by the malicious program 10 based on first time information 31 based on the encryption operation being performed on the user file 20. That is, the user may predict that the encryption operation is performed by the malicious program 10 within a predetermined time period before and after 9:34:02 am on Friday, Jun. 28, 2019.

Based on the user command related to the user file 20 being obtained (e.g., command for the execution or decryption of the user file 20), the electronic device 100 may identify the encryption key used during the encryption operation for the user file 20 based on the metadata stored in the memory 30. In this case, the electronic device 100 may identify an encryption key corresponding to the first time information 31 among at least one encryption key stored in the memory 30 based on the first time information 31. Specifically, the electronic device 100 may identify an encryption key used for an encryption operation performed within a predetermined time period from the first time information 31. Also, the electronic device 100 may identify an encryption key used for an encryption operation performed within a time range set by the user from the first time information 31. The electronic device 100 may perform the decryption operation on the user file 20 based on the identified encryption key. Accordingly, the user satisfaction may be improved.

Hereinafter, a configuration of the electronic device 100 will be described.

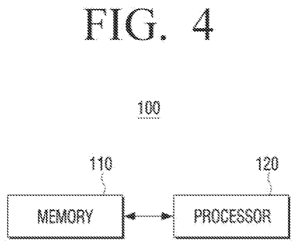

FIG. 4 is a block diagram illustrating a configuration of the electronic device according to an embodiment of the disclosure.

Referring to FIG. 4, the electronic device 100 may include a memory 110 and a processor 120. For example, the electronic device 100 may be a user terminal. Also, the electronic device 100 may be a personal PC or a mobile device. Alternatively, the electronic device 100 may be a CPU chip installed in the user terminal.

The memory 110 may store an operating system (OS) for controlling an overall operation of the components of the electronic device 100 and commands or data related to the components of the electronic device 100. To this end, the memory 110 may be implemented as a non-volatile memory (e.g., a hard disk, a solid state drive (SSD), and a flash memory), a volatile memory, or the like. For example, the memory 110 may include a first memory that is a volatile memory and a second memory that is a non-volatile memory. In this case, the malicious program 10 may perform the encryption operation in the first memory. In addition, the processor 120 may store the metadata for the encryption operation performed in the first memory and the encryption key used for the encryption operation in the second memory. Hereinafter, unless otherwise specified, the memory 420 in which the metadata and the encryption key are stored may refer to the second memory.

The memory 110 may store at least one instruction. In particular, the memory 110 may store instructions related to various operations performed by the processor 120 to be described later. For example, the memory 110 may store an instruction for identifying the hardware acceleration instruction.

The processor 120 may control the overall operation of the electronic device 100.

For example, the processor 120 may identify a first instruction used for the encryption operation on the user file using the encryption key. Here, the first instruction may mean a hardware acceleration instruction for accelerating the hardware of the user terminal. For example, the first instruction may be the ‘aeskeygenassist’ according to the advanced encryption standard (AES) algorithm. The processor 120 may scan the binary of the user file existing in the electronic device 100 to identify the first instruction and the memory address in which the first instruction is stored.

In addition, the processor 120 may obtain the encryption key used for the encryption operation and the metadata for the encryption operation based on the identification of the first instruction, and store the obtained encryption key and metadata in the memory 110.

For example, the processor 120 may obtain the encryption key and the metadata using the above-described code insertion method (binary instrumentation). Specifically, the processor 120 may insert the instruction for storing the encryption key and the metadata in the memory 110 into the memory address (e.g., the address immediately following the first instruction) separated by a predetermined value from the memory address in which the first instruction is stored. In this case, the inserted instruction may include a command for storing various types of information on the application, in addition to the identification information on the application and the information on the time based on the application being executed. Thereafter, based on the application being executed according to the user command, the processor 120 may store the encryption key and the metadata in the memory 110 by executing the inserted instruction.

As another example, the processor 120 may set the first instruction as the privileged instruction to identify the first instruction. In this case, the processor 120 may be configured to have an execution privilege for a privileged instruction at an operating system level or a hypervisor level. Thereafter, when a trap occurs as the first instruction is executed, the control privilege for the first instruction is transferred to the operating system (or kernel) or the hypervisor level. In addition, the processor 120 may obtain the encryption key and the metadata through the trap handler that processes the trap and store the obtained encryption key and metadata in the memory 110. As described above, the processor 120 may identify the execution of the first instruction without inserting a separate code for the malicious program 10.

As another example, the processor 120 may store the encryption key and the metadata in the memory 110 using a hardware breakpoint. In this case, when the processor 120 identifies the first instruction and the memory address in which the first instruction is stored, the processor 120 may set the identified memory address in the debug register as a breakpoint. In addition, based on the interrupt being detected at the breakpoint, the processor 120 may execute a predetermined routine to obtain the encryption key and the metadata and store the obtained encryption key and metadata in the memory 110.

As described above, based on the metadata stored in the memory 110 through various methods, the processor 120 may identify the encryption key used for the encryption operation on the user file 20. Specifically, the processor 120 may obtain at least one encryption key stored in the memory 110 based on the time information based on the first instruction being executed. Based on the first instruction being executed multiple times, the processor 120 may obtain a plurality of encryption keys. For example, the processor 120 may obtain a first encryption key corresponding to an n-th executed first instruction and a second encryption key corresponding to an n+1-th executed first instruction. In addition, the processor 120 may perform the decryption operation on the user file 20 using the obtained encryption key. In particular, the processor 120 may repeatedly perform the decryption operation using at least one obtained encryption key until the decryption on the user file 20 is successful.

Also, the processor 120 may obtain the encryption key based on the identification information on the application that performs the first instruction. For example, the processor 120 may obtain an encryption key for each encryption operation performed by a plurality of applications that performs the first instruction. In addition, the processor 120 may obtain the rest encryption keys excluding an encryption key for an encryption operation performed by an application having predetermined identification information among the obtained encryption keys. In this case, the processor 120 may perform the decryption operation on the user file 20 using the rest obtained encryption key. Here, the application having the predetermined identification information is an application pre-installed in the user terminal, and may be, for example, a painting board. As described above, the processor 120 does not perform the decryption operation on the user file 20 based on the encryption key used by all applications that performs the first instruction, but may perform the decryption operation only based on the encryption key used by the specific application. Accordingly, the amount of decryption computation of the electronic device 100 may be reduced.

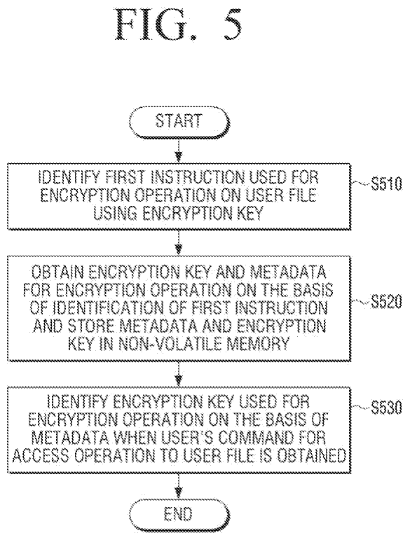

FIG. 5 is a flowchart of a method of controlling an electronic device according to an embodiment of the disclosure.

Referring to FIG. 5, the electronic device 100 identifies a first instruction used for an encryption operation on a user file using an encryption key (S510), and obtains an encryption key and metadata for the encryption operation based on the identification of the first instruction and stores the obtained encryption key and metadata in a non-volatile memory (S520). Based on a user command for an access operation to the user file being obtained, the encryption key used for the encryption operation may be identified based on the metadata (S530). Since each of the above steps may be clearly understood from the description of the operation of the electronic device 100 described above with reference to FIG. 1, the overlapping description thereof will not be repeated.

The electronic device 100 may store an encryption key and metadata for an encryption operation related to a hardware acceleration instruction performed by an application installed in the electronic device 100 after a predetermined time in the memory 30. That is, the electronic device 100 may not store an encryption key and metadata for an encryption operation related to a hardware acceleration instruction performed by an application (or program) installed and existing in the electronic device 100 from before a predetermined time in the memory 30. For example, the electronic device 100 may store an encryption key and metadata for an encryption operation performed after the time when ransomware exists in the memory 30.

In addition, the electronic device 100 may selectively store metadata and an encryption key related only to an application that executes a hardware acceleration instruction for a predetermined period from the time it is first installed in the electronic device 100 in the memory 30. Accordingly, the electronic device 100 may not store an encryption key and metadata for an encryption operation related to an application that executes a hardware acceleration instruction after a predetermined period has elapsed from the time it is first installed in the electronic device 100 in the memory 30. For example, the electronic device 100 may store the metadata for the encryption operation related only to the hardware acceleration instruction executed within 6 months from Jun. 1, 2019, based on the first application being first installed in the user terminal in the memory 30.

In addition, the electronic device 100 may selectively store the encryption key and the metadata for the encryption operation in the memory 40 based on an inspection result of the application obtained from an anti-virus engine. For example, the electronic device 100 may identify an application identified as a malicious program by the anti-virus engine among at least one application executing the hardware acceleration instruction. In addition, the electronic device 100 may store an encryption key and metadata for the encryption operation executed by the identified application in the memory 30. In this case, the anti-virus engine may analyze each binary information of a plurality of applications executing the hardware acceleration instruction to determine whether the application corresponds to the malicious program.

As such, as the electronic device 100 stores an encryption key and metadata for some selected encryption operations among all encryption operations related to the identified hardware acceleration instruction in the memory 30, the amount of computation of the electronic device 100 may be reduced, and the capacity of the encryption key and metadata occupying the memory 30 may be reduced.

The electronic device 100 may obtain the metadata and the encryption key in various ways and store the obtained metadata and encryption key in the memory 30.

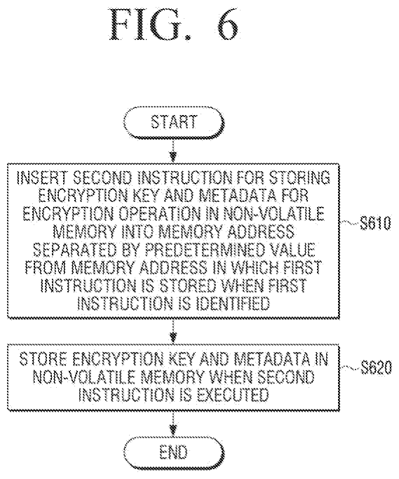

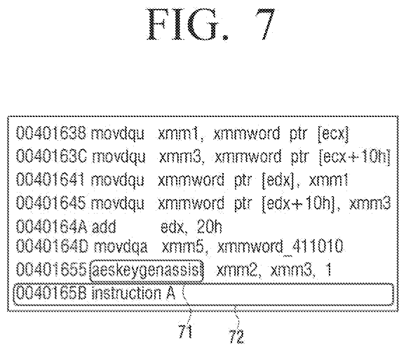

FIG. 6 is a flowchart of the method of controlling an electronic device according to an embodiment of the disclosure. Specifically, FIG. 6 is a flowchart illustrating a method of backing up metadata and an encryption key using a code insertion method. In addition, FIG. 7 is an example of binary information for describing the control method of FIG. 6.

Referring to FIG. 6, based on the first instruction being identified, the electronic device 100 may insert a second instruction for storing an encryption key and metadata for an encryption operation in a non-volatile memory into a memory address separated by a predetermined value from the memory address in which the first instruction is stored (S610), and based on the second instruction being executed, the electronic device 100 may store the encryption key and the metadata in the non-volatile memory (S620).

Based on the first instruction being identified, the electronic device 100 inserts a second instruction for storing the encryption key and the metadata for the encryption operation in the non-volatile memory into a memory address separated by a predetermined value from the memory address in which the first instruction is stored (S610). In this case, based on the application being downloaded to the user terminal, the electronic device 100 may scan the binary information of the application to identify the first instruction. Specifically, a loader in charge of loading the application may identify the first instruction by scanning the binary information of the application. Also, the electronic device 100 may obtain the memory address in which the first instruction is recorded.

Referring to FIG. 7, the electronic device 100 may identify a first instruction 71 and obtain a memory address ‘00401655’ stored in the first instruction 71. Also, the electronic device 100 may insert a second instruction 72 (Instruction A′) into a next address ‘0040165B’ of the memory address where the first instruction 71 is stored. In this case, the second instruction 72 may include a command for obtaining an encryption key and metadata for an encryption operation performed by the application executing the first instruction 71 and storing the metadata in the memory 110. The electronic device 100 may insert the second instruction 72 based on the identification information on the application that executes first instruction 71. For example, based on the first instruction 71 being executed by an application having predetermined identification information, the electronic device 100 may not insert the second instruction 72. In this case, the application having the predetermined identification information may be the application installed in the user terminal before the predetermined time point.

The second instruction 72 may be stored at an address immediately following the first instruction 71, but this is only an example, and the second instruction 72 may be stored at an address spaced apart from the first instruction 71. In this case, a jump instruction for guiding a memory address in which the second instruction 72 is stored may be stored at an address immediately following the first instruction 71. Accordingly, the electronic device 100 may execute the second instruction 72 after sequentially executing the first instruction 71 and the jump instruction. The electronic device 100 may return to an address next to the memory address in which the jump instruction is stored.

Hereinafter, a software configuration constituting the processor 120 will be described.

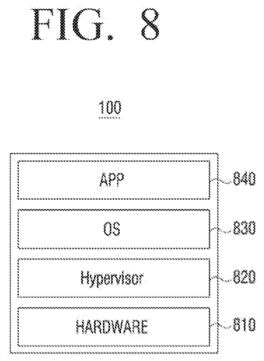

FIG. 8 is a diagram for describing a software configuration of an electronic device according to an embodiment of the disclosure.

Referring to FIG. 8, the electronic device 100 may include hardware 810, a hypervisor 820, an operating system (OS) 830, and an application (APP) 840.

When a user applies power to the electronic device 100 for the first time, the electronic device 100 executes the stored BIOS to recognize and test the hardware 810 to check whether the hardware 810 operates properly. Thereafter, the electronic device 100 initializes the hardware 810 and loads the hypervisor 820 through a boot loader. Thereafter, the electronic device 100 initializes the hypervisor 820 and then loads and executes the operating system 830 used in the system. As described above, the control privilege of the hypervisor 820 may be higher than that of the OS 830 according to the order in which power is applied to the electronic device 100 and each component of the electronic device 100 operates.

Accordingly, even if the operating system 830 is infected with a malicious program, the hypervisor 820 may be safely protected.

The operating system 830 may control the overall operation of the hardware 810 and perform a function of managing the hardware 810 and a process corresponding to each application. That is, the OS 830 is a layer in charge of basic functions such as hardware management, memory, and security. The OS 830 may process an application call, and may operate the hardware 810 according to the processing result.

An application 840 layer that performs various operations exists in an upper layer of the OS 830. Each application 840 may provide a user interface.

In particular, the hypervisor 820 may identify an instruction set as the privileged instruction and operations to be performed based on a trap being generated. Then, when the application 840 tries to execute a privileged instruction according to a user command, the trap is generated and the control privilege for the corresponding instruction is sequentially transferred to the hypervisor 820 through the OS 830. For example, the hardware acceleration instruction that prepares an encryption key at a specific address may be configured as the privileged instruction. Based on the hardware acceleration instruction being called by the application 840, the trap may be generated and the hypervisor 820 may have the control privilege for the hardware acceleration instruction. In this case, the hypervisor 820 may execute the called hardware acceleration instruction and back up the encryption key and the metadata on the encryption key.

The hypervisor 820 may execute the privileged instruction in response to a request from the upper OS 830. That is, the control privilege of the hypervisor 820 may be higher than that of the OS 830. Accordingly, even if the OS 830 and the application 840 of the upper layer are exposed by an external attacker, the external attacker does not have control privilege over the hypervisor 820. Accordingly, the hypervisor 820 may operate normally even if the OS 830 and the application 840 are exposed by the external attacker, and may back up the encryption key and metadata for the encryption operation performed in the electronic device 100. Accordingly, the security level of the electronic device 100 may be maintained.

Although it has been described above that the electronic device is configured with a single working environment, embodiments of disclosure are not limited thereto, and the software configuration of the electronic device may be configured with a plurality of working environments. In addition, the layer immediately below the hypervisor 820 does not necessarily have to be implemented as the hardware 810, and may be implemented in a form in which a separate OS layer exists between the hypervisor 820 and the hardware 810.

The embodiments of the disclosure described above may be implemented in a computer or a computer readable recording medium using software, hardware, or a combination of software and hardware. In some cases, embodiments described in the disclosure may be implemented by the processor itself. According to a software implementation, embodiments such as procedures and functions described in the disclosure may be implemented by separate software modules. Each of the software modules may perform one or more functions and operations described in the disclosure.

Computer instructions for performing processing operations according to the diverse embodiments of the disclosure described above may be stored in a non-transitory computer-readable medium. The computer instructions stored in the non-transitory computer-readable medium allow a specific machine to perform the processing operations according to the diverse embodiments described above based on they being executed by a processor.

The non-transitory computer-readable medium is not a medium that stores data for a while, such as a register, a cache, a memory, or the like, but means a medium that semi-permanently stores data and is readable by the apparatus. A specific example of the non-transitory computer-readable medium may include a compact disk (CD), a digital versatile disk (DVD), a hard disk, a Blu-ray disk, a universal serial bus (USB), a memory card, a read only memory (ROM), or the like.

Although embodiments of the disclosure have been illustrated and described hereinabove, the disclosure is not limited to the abovementioned specific embodiments, but may be variously modified by those skilled in the art to which the present disclosure pertains without departing from the spirit of the disclosure as disclosed in the accompanying claims. These modifications should also be understood to fall within the scope and spirit of the disclosure.

What is claimed is:

1. A method of controlling an electronic device, the method comprising:
identifying a first instruction for an encryption operation on a file using an encryption key;
based on the first instruction being identified, obtaining the encryption key and metadata for the encryption operation and storing the obtained encryption key and the metadata in a non-volatile memory; and
based on a user command for an access operation to the file being obtained, identifying the encryption key used for the encryption operation based on the metadata.

2. The method of claim 1, wherein in the identifying the encryption key comprises identifying the encryption key based on information on a memory address in which the encryption key included in the metadata is stored.

3. The method of claim 1, wherein the storing the obtained encryption key and the metadata comprises:
based on the first instruction being identified, inserting a second instruction for storing the encryption key and the metadata for the encryption operation in the non-volatile memory into a memory address separated by a predetermined value from the memory address in which the first instruction is stored; and
based on the second instruction being executed, storing the encryption key and the metadata in the non-volatile memory.

4. The method of claim 1, further comprising:
setting the first instruction as a privileged instruction to identify the first instruction,
wherein the obtaining the encryption key and the metadata comprises, based on a trap being identified as the first instruction set as the privileged instruction is executed, obtaining the encryption key and the metadata through a trap handler that processes the trap.

5. The method of claim 1, wherein the storing the encryption key and the metadata comprises:
based on the first instruction and a memory address in which the first instruction is stored being identified, setting the identified memory address as a breakpoint in a debug register of the electronic device; and
based on an interrupt being detected at the breakpoint, executing a predetermined routine to obtain the encryption key and the metadata and storing the obtained encryption key and the metadata in the non-volatile memory.

6. The method of claim 1, further comprising:
performing a decryption operation on the file using the identified encryption key,
wherein the performing of the decryption operation comprises:
obtaining at least one encryption key based on information on a time based on the first instruction being executed, and
performing the decryption operation on the file using the obtained encryption key.

7. The method of claim 1, wherein the storing the obtained encryption key and the metadata comprises:
identifying other applications excluding a first application having predetermined identification information among at least one application based on the identification information on the at least one application that executes the first instruction, and
obtaining an encryption key and metadata for an encryption operation performed by the other applications and storing the encryption key and the metadata for the encryption operation performed by the other applications in the non-volatile memory.

8. An electronic device comprising:
a memory configured to store at least one instruction; and
a processor configured to execute the at least one instruction to:
identify a first instruction for an encryption operation on a file using an encryption key,
based on the first instruction being identified, obtain the encryption key and metadata for the encryption operation and store the obtained encryption key and the metadata in a non-volatile memory, and
based on a user command for an access operation to the file being obtained, identify the encryption key used for the encryption operation based on the metadata.

9. The electronic device of claim 8, wherein the processor is further configured to execute the at least one instruction to identify the encryption key based on information on a memory address in which the encryption key included in the metadata is stored.

10. The electronic device of claim 8, wherein the processor is further configured to execute the at least one instruction to:
based on the first instruction being identified, insert a second instruction for storing the encryption key and the metadata for the encryption operation in the non-volatile memory into a memory address separated by a predetermined value from the memory address in which the first instruction is stored, and
based on the second instruction being executed, store the encryption key and the metadata in the non-volatile memory.

11. The electronic device of claim 8, wherein the processor is further configured to execute the at least one instruction to:
set the first instruction as a privileged instruction to identify the first instruction, and
based on a trap being identified as the first instruction set as the privileged instruction is executed, obtain the encryption key and the metadata through a trap handler processing the trap and stores the obtained encryption key and metadata in the non-volatile memory.

12. The electronic device of claim 8, wherein the processor is further configured to execute the at least one instruction to:
based on the first instruction and a memory address in which the first instruction is stored being identified, set the identified memory address as a breakpoint in a debug register of the electronic device, and
based on an interrupt being detected at the breakpoint, execute a predetermined routine to obtain the encryption key and the metadata and store the encryption key and the metadata in the non-volatile memory.

13. The electronic device of claim 8, wherein the processor is further configured to execute the at least one instruction to:
perform a decryption operation on the file using the identified encryption key,
obtain at least one encryption key based on information on a time based on the first instruction being executed, and
perform the decryption operation on the file using the obtained encryption key.

14. The electronic device of claim 8, wherein the processor is further configured to execute the at least one instruction to:
identify other applications excluding a first application having predetermined identification information among at least one application based on the identification information on the at least one application that executes the first instruction, and
obtain an encryption key and metadata for an encryption operation performed by the other applications and store the obtained encryption key and metadata for the encryption operation performed by other applications in the non-volatile memory.
